(19) United States
(12) Patent Application Publication
(10) Pub. No.: US 2014/0110346 A1
(43) Pub. Date: Apr. 24, 2014

(54) FLOTATION PROCESS FOR THE REDUCTION OF PARTICLE CONTENT IN COOLING WATER

(71) Applicants: Marcus Guzmann, Munsing (DE); Arthur I. Shirley, Hillsborough, NJ (US)

(72) Inventors: Marcus Guzmann, Munsing (DE); Arthur I. Shirley, Hillsborough, NJ (US)

(21) Appl. No.: 14/044,137

(22) Filed: Oct. 2, 2013

Related U.S. Application Data
(60) Provisional application No. 61/715,501, filed on Oct. 18, 2012.

(51) Int. Cl. C02F 1/24; C02F 1/54; C02F 1/56; C02F 1/52

(52) U.S. Cl. CPC C02F 1/24; C02F 1/5236; C02F 1/545; C02F 1/547; C02F 1/56
USPC 210/705; 210/703; 210/704

(57) ABSTRACT

Systems and methods for removing particles from cooling water employing a flotation process to remove particulate matter from the cooling water, particularly during times of the year when particle content in the water is at its peak.

The present invention relates to cooling processes for industrial uses utilizing water from natural sources.

### BACKGROUND OF THE INVENTION

Cooling water is used in a number of industrial operations for equipment, piping and the like. Generally, this cooling water is provided directly from the sea, the ocean a lake or a river. The water from these sources often contains particles or contaminants that can cause damage to plant equipment, such as abrasion of pipes, pumps, cooling towers, etc. The damaged equipment may need to cleaned, repaired or replaced adding significant cost to the operation of the plant as well as resulting in servicing downtime for the equipment and plant.

Methods of overcoming the damage caused by particles in the cooling water include the addition of other equipment, such as cyclones or filters. However, the additional equipment adds significant expense for the plant. Further, the use of cyclones or filters is impractical when the volume of cooling water is high and the water needs to be treated continuously. The added equipment requires regular servicing resulting in plant downtime for such service or possible replacement resulting in additional expense and downtime.

There remains a need in the art for improvement in the field of the supply of cooling water to industrial applications.

### SUMMARY OF THE PRESENT INVENTION

The invention provides improved systems and methods for removing particles from cooling water. In particular, the invention employs a flotation process to remove particulate matter from the cooling water during times of the year when particle content in the water is at its peak.

### DETAILED DESCRIPTION OF THE INVENTION

The present invention provides systems and methods for removing particles from cooling water. As noted, the use of natural sources of water, e.g. the sea, ocean, lakes or rivers is common for cooling water applications. However, these water sources may have particulate matter that can damage other equipment in the plant and therefore needs to be removed prior to the cooling operation.

Filters or cyclones are expensive and do not present an economical solution to the problem. This is partly because the amount of particles in the water source varies at different times of the year. For example, water from the Gulf of Mexico is generally low in particle concentration, i.e. from 200-400 ppm suspended solids for about 300 days during the year. However, during the rainier season, particle concentration can be as high as 60,000 ppm suspended solids. This period can extend for 20 to 60 days during the year.

The amount of water recycled in a cooling tower can be 25 m³/sec with fresh water make up of 1.2 m³/sec. Cooling tower loss from evaporation or misting can account for 0.8 m³/sec. These high volumes need to be treated continuously for particle removal, only during the 20 to 60 days during the year when suspended solids are high. Therefore, employing an integral filter or cyclone system continuously for the whole year is not necessary and not economical. Further, filters can become plugged with particulate matter, such as sand, over time and reduce the flow of cooling water. This then requires system shutdown for maintenance and cleaning.

The invention makes use of a flotation process to remove the particulate matter from the cooling water. The flotation process of the invention involves the following stages.
Injection of air in the bottom of a container holding the water to be treated.
Skimming froth containing solid particles from the surface and edges of the container.
Optionally adding chemicals, such as surfactants or polymers to the water being treated.

When the air is injected, it creates bubbles in the water. These bubbles can trap the particles and float them to the surface where they can be removed by skimming. Optionally, the particles can be treated with chemicals to be hydrophobic modified particles that are preferentially absorbed by the bubbles. In order to modify the particles, it is important to select the right chemicals based on criteria including, the chemical composition of the particle, the ion content in the water (aqueous medium), and the pH.

For example, if the particle is sand then the surface net charge will be negative. Therefore according to the invention, a cationic surfactant containing a hydrophobic tail can be used to attach to the particle and create a hydrophobic surface. Alternatively, a cationic low molecular weight polymer (Mw less than 30,000 g/mol) that has been hydrophobically modified, such as copolymers based on acrylic acid, acrylamide, maleic acid, maleic acid esters, alpha olefins, acrylic acid esters, partially hydrolyzed acrylamide derivatives or canonically modified acrylamide derivatives can be used.

If the particle is clay, then the surface net charge will be positive. In this case anionic surfactants, such as sulfonates, sulfates, or carboxylic based surfactants can be used. Alternatively, anionic low molecular weight polymers (Mw less than 30,000 g/mol) that have been hydrophobically modified, such as copolymers based on acrylic acid, acrylamide, maleic acid, alpha olefins, acrylic acid esters, or condensation products of naphtalenesulphonic acid can be used.

If a surfactant is added, it should be chosen so that it does not create foam. In the event foam is generated by the surfactant, then a defoamer agent can be added. Such defoamers include silicon based chemicals and amphiphilic block copolymers. Further, a flocculant may be added to the system to cause aggregation of smaller particles into large ones and therefore increase the removal process efficiency.

The system of the invention is designed as a compatible chemical system taking into account the different chemical characteristics and nature of the particles being removed. Further, the invention contemplates the use of biodegradable chemicals that are non-toxic and non-harmful for both standard conditions and maritime conditions.

The invention provides several advantages. In particular, the invention provides a low cost solution because the chemical treatment and air injection are only employed when the particle concentration exceeds a predetermined level and need to be removed to avoid damage to the plant equipment. Implementation of the invention into existing facilities is easy as no additional permanent equipment is necessary. Further, there are no filters employed, thus avoiding blockage of such filters. This allows the system of the invention to operate at a constant flow of cooling water.

By removing the damaging particles from the cooling water according to the invention, the lifetime of other plant equipment, such as pumps, cooling towers, and piping can be increased.

It is anticipated that other embodiments and variations of the present invention will become readily apparent to the skilled artisan in the light of the foregoing description, and it is intended that such embodiments and variations likewise be included within the scope of the invention as set out in the appended claims.

What is claimed:

1. A methods of treating water to remove particulate matter comprising:
injecting air into the bottom of a container holding the water to be treated to create bubbles that trap the particulate matter; and
skimming froth created by the bubbles with trapped particulate matter from the surface of the water in the container.

2. The method according to claim 1, wherein the water being treated is to be used as cooling water for an industrial application.

3. The method according to claim 1, further comprising adding chemicals to the water to be treated to hydrophobically modify the particulate matter such that the particulate matter will be preferentially absorbed by the bubbles.

4. The method according to claim 3, wherein the particulate matter is sand and the chemical added to the water is a cationic surfactant containing a hydrophobic tail.

5. The method according to claim 3, wherein the particulate matter is sand and the chemical added to the water is a cationic low molecular weight polymer.

6. The method according to claim 5, wherein the polymer has a molecular weight of less than 30,000 g/mol.

7. The method according to claim 5, wherein the polymer is a copolymer based on acrylic acid, acrylamide, maleic acid, maleic acid esters, alpha olefins, acrylic acid esters, partially hydrolyzed acrylamide derivatives or cationically modified acrylamide derivatives.

8. The method according to claim 3, wherein the particulate matter is clay and the chemical added to the water is an anionic surfactant.

9. The method according to claim 8, wherein the anionic surfactant is a sulfonate, sulfate, or carboxylic based surfactant.

10. The method according to claim 3, wherein the particulate matter is clay and the chemical added to the water is an anionic low molecular weight polymer.

11. The method according to claim 10, wherein the polymer has a molecular weight of less than 30,000 g/mol.

12. The method according to claim 10, wherein the polymer is a copolymer based on acrylic acid, acrylamide, maleic acid, alpha olefins, acrylic acid esters or condensation products of naphtalenesulphonic acid.

13. The method according to claim 3, further comprising adding a defoamer agent to the water to be treated.

14. The method according to claim 13 wherein the defoamer agent is a silicon based chemical or amphiphilic block copolymer.

15. The method according to claim 3, further comprising adding a flocculant to the water to be treated.
